(19) United States
(12) Patent Application Publication
(10) Pub. No.: US 2020/0369577 A1
(43) Pub. Date: Nov. 26, 2020

(54) PRODUCTION OF FERTILIZERS FROM LANDFILL GAS OR DIGESTER GAS

(71) Applicant: HALDOR TOPSØE A/S, Kgs. Lyngby (DK)

(72) Inventors: Niklas Bengt JAKOBSSON, Kågeröd (SE); Kurt Agerbæk CHRISTENSEN, Birkerød (DK); Janus Emil MÜNSTER-SWENDSEN, Espergærde (DK); Kresten EGEBLAD, Farum (DK)

(73) Assignee: HALDOR TOPSØE A/S, Kgs. Lyngby (DK)

(21) Appl. No.: 16/961,332

(22) PCT Filed: Feb. 11, 2019
(86) PCT No.: PCT/EP2019/053289

§ 371 Date: Jul. 10, 2020

(30) Foreign Application Priority Data
Feb. 13, 2018 (DK) PA 2018 00069

(51) Int. Cl. C05C 3/00; C05D 9/00

(52) U.S. Cl. CPC C05C 3/00; C01B 17/64; C05D 9/00

(57) ABSTRACT

In a method for the production of a fertilizer from the sulfur and ammonia content in a feed gas, including steps of (a) combustion of the H₂S-rich gas in air to convert H₂S to SO₂, (b) formation of ammonium hydrogen sulfite (AHS) by absorption of SO₂ and NH₃ in water, and (c) reaction of the AHS from step (b) with H₂S and NH₃ to form an aqueous solution of ammonium thiosulfate (ATS), reaction (a) is carried out in a catalytic reactor as a selective oxidation of the H₂S content to SO₂ over a selective catalyst having one or more metal oxides, in which the metal is selected from the group of V, W, Ce, Mo, Fe, Ca and Mg, and one or more supports taken from the group of Al₂O₃, SiO₂, SiC and TiO₂, optionally in the presence of other elements in a concentration below 1 wt %.

### TECHNICAL FIELD

The present invention relates to the production of high value fertilizers from various off-gases. More specifically, the invention relates to using the ammonium thiosulfate (ATS) process to produce a high value fertilizer from the sulfur and ammonia content in gases such as landfill gas, digester gas, off-gas from geothermal power production or coke oven gas.

### BACKGROUND

The ATS process is a referenced technology from the Applicant which is used to clean refinery off-gases from sour water stripper (SWS), amine regenerator off-gas and/or Claus plant tail gas for H₂S and NH₃. The product is a 50-60% aqueous solution of ammonium thiosulfate, which can be used directly as a fertilizer because it is consistent with the standards for sale and distribution of ATS fertilizers.

The ATS process is based on the three following main reactions:

1. Combustion of a gas rich in H₂S with atmospheric air in a combustor:

4H₂S+6O₂→4H₂O+4SO₂ (1)

2. Formation of ammonium hydrogen sulfite (AHS) by absorption of SO₂ and NH₃ in water:

4SO₂+4NH₃+4H₂O→4NH₄HSO₃ (2)

3. Reaction of the AHS from reaction (2) with H₂S and NH₃ to form an aqueous solution of ammonium thiosulfate (ATS):

4NH₄HSO₃+2H₂S+2NH₃→3(NH₄)₂S₂O₃+3H₂O (3)

It can be seen from the above reactions (1)-(3) that the stoichiometric ratio between H₂S and NH₃ is 1:1, and that 2/3 of the H₂S is used for formation of SO₂ and 1/3 is used for ATS formation. Likewise, 2/3 of the NH₃ is used for AHS formation and 1/3 is used for ATS formation.

The main advantages of the ATS process are that the product is a high value fertilizer and that the process can utilize off-gas containing H₂S and NH₃, such as the SWS gas and Claus feed gas normally processed in refineries, as feedstock. In addition, due to the preferred design with two SO₂ scrubbers in series connection, very low levels of sulfur emission can be accomplished.

The gas flows as well as the content of sulfur and ammonia are much lower in the landfill gas and digester industry. The Applicant's efforts within processes relating to removal of siloxanes and transformation of landfill gas (LFG) to renewable natural gas (RNG) have shown that for gases with a significant sulfur content, the current sulfur removal technologies used in the industry are absorption techniques, Lo-Cat type technology, biological units or caustic H₂S scrubbing. Regarding the digester industry, a technique comprising several steps of water scrubbing at elevated pressure is often used.

Actually, the current ATS technology is a non-catalytic process that converts a part of the H₂S feed to SO₂ through thermal combustion, and thus the technology is not in itself applicable for gases such as LFG, digester gas and coke oven gas, where the hydrocarbons (mainly methane) need to be conserved as a valuable product.

The current ATS technology is i.a. described by the Applicant in U.S. Pat. No. 6,159,440 B1 and U.S. Pat. No. 7,052,669 B2, both dealing with methods for the production of ammonium thiosulfate. A further process for producing ammonium thiosulfate, more particularly a process for producing ammonium thiosulfate from a feed gas stream containing a mixture of NH₃ and H₂S, is described in WO 02/072243 A1.

U.S. Pat. No. 6,444,185 B1 discloses a process for recovering residual H₂S, SO₂, COS and CS₂ in the tail gas from a sulfur recovery process. The removal of these sulfur compounds is virtually total, and the compounds are removed in the form of elemental sulfur.

A process for the conversion of H₂S to SO₂ in a feed gas containing H₂S by oxidation with air or oxygen at temperatures between 150 and 480° C. is described in U.S. Pat. No. 4,088,743 A. An extremely stable oxidation catalyst, preferably V₂O₅ on hydrogen mordernite or alumina, is used. The process is especially contemplated for use in treating waste gases from geothermal steam power plants.

US 2003/0194366 A1 relates to catalysts and methods for selective oxidation of H₂S in a gas stream containing one or more oxidizable components other than H₂S to generate SO₂, elemental S or both without substantial oxidation of the oxidizable components other than H₂S.

A method for oxidizing H₂S to generate SO₂, elemental S or both is disclosed in WO 2013/002791 A1. The method includes contacting a gas stream containing H₂S with oxygen and a catalyst comprising one or more alkali metals, one or more alkaline earth metals or a combination thereof supported on silica, where the catalyst does not contain a transition metal.

In U.S. Pat. No. 6,652,827 B1, a process for the recovery of sulfur from a gas containing hydrogen sulfide is described. The process comprises oxidizing a part of the H₂S in a gaseous stream to SO₂ with oxygen, reacting the product gas in at least two catalytic stages in accordance with the Claus equation (2H₂S+SO₂→2H₂O+3/n Sₙ) and catalytically reducing SO₂ in the gas leaving the last of said at least two catalytic stages, where this catalytic reduction takes place in a catalyst bed downstream from the last catalytic Claus stage.

A method for removing sulfur compounds from a gas stream and converting them to elemental sulfur in a Claus reaction is also described in U.S. Pat. No. 8,703,084 B2. The method comprises injecting water so that the feed stream contains >10 vol % water equivalents, passing the feed stream through a catalyst which hydrogenates or hydrolyzes COS and/or CS₂ to H₂S, injecting O₂ so that the stoichiometric ratio of O₂ to H₂S is at least 0.5:1.0, and passing the stream through a reaction zone having oxidation catalyst means which oxidizes H₂S to SO₂ or elemental sulfur (depending on the amount of oxygen and water added), where the temperature of the reaction zone is above the dew point of elemental sulfur.

### SUMMARY

The idea underlying the present invention is to use a specific class of catalysts to replace the usual thermal oxidation with a selective oxidation of the H₂S content to SO₂. If the temperature is sufficiently low, the ammonia in the gas can largely be left unconverted. Depending on the complexity of the feed gas, it may become important to get rid of heavy or water soluble non-methane hydrocarbons in the feed gas stream, either by catalytically converting them or by removing them through absorption, to avoid excessive contamination of the product stream which will be an aqueous solution with 55-60% ATS. For siloxane-containing feed gases, such as some digester gases, the gas has to be pre-treated, e.g. using Applicant's GECCO™ siloxane removal technology. Controlling the water content of the feed may have to be addressed, but reverse osmosis or evaporation could be viable ways to reduce the water content of the liquid product stream, if necessary. An alternative way is to remove water from the feed gas by cooling and producing a sour water condensate. The sour water, which is a lean solution of NH₄HS, can subsequently be separated into water and SWS gas in a sour water stripper (SWS) operation known from refineries. The SWS gas, which may contain 30 vol % H₂S, 30 vol % NH₃ and 40 vol % H₂O, can be sent to the ATS reactor as a concentrated stream.

So the present invention relates to a method for the production of a fertilizer from the sulfur and ammonia content in a feed gas such as landfill gas, digester gas, off-gas from geothermal power production or coke oven gas, said method comprising the steps of:
(a) combustion of the H₂S-rich gas with oxygen to convert H₂S to SO₂,
(b) formation of ammonium hydrogen sulfite (AHS) by absorption of SO₂ and NH₃ in water, and
(c) reaction of the AHS from step (b) with H₂S and NH₃ to form an aqueous solution of ammonium thiosulfate (ATS),
wherein reaction (a) is carried out in a catalytic reactor as a selective oxidation of the H₂S content to SO₂ over a selective catalyst consisting of one or more metal oxides, in which the metal is selected from the group consisting of V, W, Ce, Mo, Fe, Ca and Mg, and one or more supports taken from the group consisting of Al₂O₃, SiO₂, SiC and TiO₂, optionally in the presence of other elements in a concentration below 1 wt %.

It is preferred that the inlet temperature to reaction (a) is restricted to levels of less than 350° C., preferably less than 300° C., more preferred less than 250° C. and most preferred less than 200° C.

In the method of the invention, NH₃ is preferably added by decomposition of an ammonia precursor, such as urea. The source of ammonia can advantageously be urea decomposed by thermal or catalytic decomposition in a mixture with air. The hot gas from the above step (a) can be used as a heat source.

The source of ammonia is preferably urea decomposed by thermal or catalytic decomposition in a mixture with a gas where CO₂ is the main gaseous component to avoid excessive amounts of oxygen and nitrogen in the product gas. However, the CO₂ rich gas must have sufficient oxygen and water to allow for the decomposition reaction to proceed.

In the method of the invention, absorption or scrubbing is carried out in an absorption section comprising at least two absorbers in series connection. It is noted that in this specification, the words “absorption” and “scrubbing” are used interchangeably.

The above reaction (c) is preferably carried out in a reactor provided with a structured packing material.

The final ATS product can be concentrated through use of reverse osmosis.

In the method of the invention, the small amounts of SO₃ formed in step (a) react with water to form sulfuric acid vapor, of which a part condenses as small droplets. Preferably an aerosol filter is installed to treat the product gas downstream from step (b) in order to reduce or eliminate emission of sulfuric acid mist in the product gas. The filter can advantageously be a low velocity candle filter or a wet electrostatic precipitator. The liquid drain from the filter can optionally be returned to the liquid of the second absorber.

In the method of the invention, step (a) can also convert sulfur compounds other than H₂S, such as elemental sulfur, COS, CS₂ and mercaptans.

The oxygen content in the gas leaving the selective catalytic step is below 1%, preferably below 0.5%, more preferred below 0.2% and most preferred below 0.1%.

Conventional technology for CO₂ and N₂ removal, such as amine scrubbing for CO₂ removal and pressure swing adsorption for N₂ removal, is preferably installed downstream of the absorption steps, thereby upgrading the gas to natural gas pipeline quality.

The selective catalyst can be a monolithic type catalyst, which can tolerate higher amounts of dust and particulates in the gas without causing plugging in the system.

A monolithic type catalyst can be an extruded, corrugated metal sheet or a corrugated fibrous monolith substrate coated with a supporting oxide. It is preferably coated with TiO₂ and subsequently impregnated with V₂O₅ and/or WO₃. The channel diameter of the corrugated monolith is between 1 and 8 mm, preferably around 2.7 mm. The wall thickness of the corrugated monolith is between 0.1 and 0.8 mm, preferably around 0.4 mm. This catalyst can be manufactured from various ceramic materials used as a carrier, such as titanium oxide, and active catalytic components are usually either oxides of base metals (such as vanadium, molybdenum and tungsten), zeolites, or various precious metals. Catalysts of monolithic structure are known to provide a favourable performance with respect to selectivity when the desired reaction is fast and any undesired reaction is slow. This is also the case in the present invention, where the conversion of H₂S to SO₂ is a fast reaction that benefits from the high surface area.

The reactor provided with the selective catalyst should be operated at a minimum excess of oxygen to prevent further oxidation of AHS or diammonium sulfite (DAS) to any excessive extent. In addition, the oxygen content should be kept at a minimum to avoid excessive amounts of oxygen and nitrogen (if air is used as oxidant) in order to not introduce higher levels of oxygen and nitrogen which need to be removed from the gas in connection with pipeline injection or use as vehicle fuel gas. The amount of oxygen in the reactor effluent should be below 1%, preferably below 0.5%, more preferred below 0.2% and most preferred below 0.1%.

The reaction (a) should be performed at a minimum outlet temperature to avoid formation of SO₃ which will also form sulfate. This precaution can be accomplished by restricting the inlet temperature to levels of less than 350° C., preferably less than 300° C., more preferred less than 250° C. and most preferred less than 200° C. Temperature control can also be achieved by dilution of the H₂S-containing feed gas to the reactor. The preferred dilution gas should be CO₂-extracted downstream from the sulfur treatment technology described in connection with this invention. More specifically, it should be extracted downstream from unit 15 in the FIGURE of the example which follows. It is preferred that the content of sulfite in the final ATS solution is below 1 wt % DAS.

The reactor, in which the H₂S is contacted with the AHS and DAS, is normally a bubble column reactor, but for dilute gases such as digester gas and LFG, it is beneficial to use a structured packing reactor to increase the contact surface between gas and liquid.

The outlet from the catalytic unit and the operating temperature of the final scrubber should be set such that a sufficient amount of water leaves the ATS unit in this stream order to facilitate that a 55-60% ATS solution can be accomplished.

The SO₂ absorbers are operated at pH values which ensure high absorption efficiencies for both SO₂ and NH₃. At low pH values, the SO₂ slip increases, and at high pH values, the NH₃ slip increases. Consequently, the absorbers should be operated at pH values in the range 4.5 to 7.5, preferably 5 to 7 and most preferred 5.5 to 6.2.

The ATS reaction is a reaction between hydrogen sulfide and hydrogen sulfite. At low pH, the concentration of [HS⁻] is low, and at high pH, the concentration of [HSO₃⁻] is low. Also at low pH, ATS decomposes to elemental sulfur and sulfite. Consequently, the ATS reactor should be operated at pH values in the range 6.5 to 9, preferably 7 to 8.5 and most preferred 7.4 to 8.3.

As the process gas from the catalytic oxidation (SMC type) is quenched or cooled using a feed effluent heat exchanger or indirect cooling upstream of or within the first absorber, the SO₃ reacts with water to form sulfuric acid vapour, and some of the sulfuric acid condenses as small droplets. These droplets are not efficiently captured in the absorbers, and in order to reduce or eliminate emission of sulfuric acid mist, an aerosol filter can be installed downstream of the second absorber. The filter can be a low velocity candle filter or a wet electrostatic precipitator. The liquid drain from this filter can be returned to the liquid of the second absorber.

### BRIEF DESCRIPTION OF THE DRAWINGS

FIG. 1 shows a process wherein H₂S and NH₃ contained in an off-gas from a digester are converted to an aqueous solution of ammonium thiosulfate.

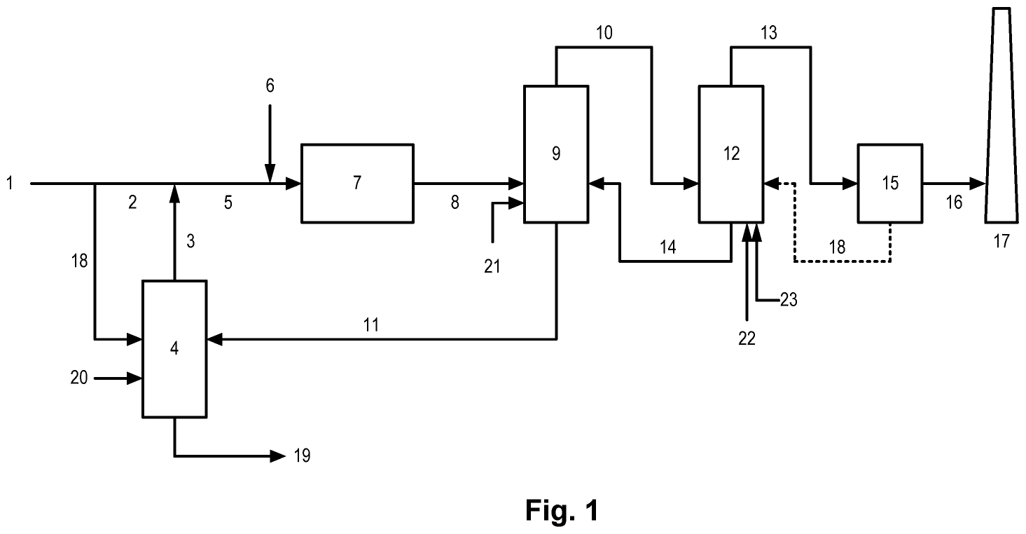

### DETAILED DESCRIPTION

The invention is illustrated in more detail in the example which follows. In the example, reference is made to the appended FIGURE.

### EXAMPLE

In this example, the H₂S and NH₃ contained in an off-gas from a digester are converted to an aqueous solution of ammonium thiosulfate in the process illustrated in the FIGURE. The feed gas (1) in an amount of 2800 Nm³/h contains 58 vol % CH₄, 39 vol % CO₂, 2.4% H₂O, 0.5 vol % H₂S and 0.1 vol % NH₃. The feed gas is split into two streams, where the main part (2) is mixed with the effluent (3) from the ATS reactor (4). Air (6) is added to the mixed stream (5), and the combined stream is sent to the catalytic reactor (7), in which H₂S is oxidized selectively to SO₂ over an SMC-type catalyst, which does not convert CH₄.

The SO₂-containing stream (8) is contacted with an aqueous solution of AHS and DAS in the first absorber (9) at 30° C. and a pH of 5.8 to produce a partially cleaned gas (10) and a rich AHS solution (11) containing 44 wt % AHS and 2 wt % DAS. The temperature of the first absorber is controlled by means of heat exchange with cooling water. The effluent gas (10) is further cleaned in a second absorber (12) by contact with an aqueous solution of AHS and DAS at 28° C. and a pH of 5.8 to produce a cleaned gas (13) and a lean AHS solution (14) containing 9.6 wt % AHS and 0.4 wt % DAS. A mist filter (15) can be installed downstream the second absorber to capture aerosol droplets formed from small amounts of SO₃ and H₂SO₄ in the effluent (8) from the catalytic reactor.

The cleaned gas (16) is sent to the stack (17) or to further processing, and the mist filter drain liquid (18) is returned to the second absorber (12). The rich AHS solution (11) is contacted with a fraction of the feed gas (18) in the ATS reactor (4) at 37° C. and a pH of 7.5 to produce the ATS product (19), which is an aqueous solution of 55 wt % ATS with small amounts of AHS and DAS. The pH values in the ATS reactor (4), the first absorber (9) and the second absorber (12) are controlled by addition of small amounts of NH₃ via streams (20), (21) and (22). The ATS concentration is controlled by addition of water (23) to the second absorber.

An overview of the main streams is given in Tables 1 and 2 below.

TABLE 1

Stream

| | 1 | 5 | 8 | 16 |
|---|---|---|---|---|
| | Mol % | Mol % | Mol % | Mol % |
| H₂S | 0.5 | 0.33 | 0 | 0 |
| H₂O | 2.4 | 3.1 | 3.4 | 3.6 |
| O₂ | 0 | 0 | 0.1 | 0.1 |
| NH₃ | 0.1 | 0.30 | 0.29 | 0.0005 |
| SO₂ | 0 | 0 | 0.32 | 0.0050 |
| CO₂ | 39 | 38.7 | 37.7 | 37.8 |
| CH₄ | 58 | 57.5 | 56.0 | 56.3 |
| N₂ | 0 | 0 | 2.2 | 2.2 |
| Total (Nm³/h) | 2800 | 2822 | 2901 | 2886 |

TABLE 2

| | Stream | | |
|---|---|---|---|
| | 11 | 14 | 19 |
| | wt % | wt % | wt % |
| ATS | 0 | 0 | 55 |
| DAS | 2 | 0.5 | 0.4 |
| AHS | 44 | 9.6 | 0.2 |
| H₂O | 54 | 89.9 | 44.4 |
| Total(kg/h) | 89 | 53 | 83 |

1. A method for the production of a fertilizer from the sulfur and ammonia content in a feed gas such as landfill gas, digester gas, off-gas from geothermal power production or coke oven gas, said method comprising the steps of:
(a) combustion of the H₂S-rich gas with oxygen to convert H₂S to SO₂,
(b) formation of ammonium hydrogen sulfite (AHS) by absorption of SO₂ and NH₃ in water, and
(c) reaction of the AHS from step (b) with H₂S and NH₃ to form an aqueous solution of ammonium thiosulfate (ATS),
wherein reaction (a) is carried out in a catalytic reactor as a selective oxidation of the H₂S content to SO₂ over a selective catalyst consisting of one or more metal oxides, in which the metal is selected from the group consisting of V, W, Ce, Mo, Fe, Ca and Mg, and one or more supports taken from the group consisting of Al₂O₃, SiO₂, SiC and TiO₂, optionally in the presence of other elements in a concentration below 1 wt %.

2. Method according to claim 1, wherein the inlet temperature to reaction (a) is restricted to levels of less than 350° C.

3. Method according to claim 1, wherein NH₃ is added by decomposition of an ammonia precursor.

4. Method according to claim 1, wherein the source of ammonia is urea decomposed by thermal or catalytic decomposition in a mixture with air.

5. Method according to claim 4, wherein the hot gas from step (a) is used as a heat source.

6. Method according to claim 1, wherein the source of ammonia is urea decomposed by thermal or catalytic decomposition in a mixture with a gas, in which CO₂ is the main gaseous component to avoid excessive amounts of oxygen and nitrogen in the product gas.

7. Method according to claim 1, wherein wet SO₂ absorption is carried out in an absorption section comprising at least two absorbers in series connection.

8. Method according to claim 1, wherein reaction (c) is carried out in a reactor with a structured packing material.

9. Method according to claim 1, wherein the final ATS product is concentrated through reverse osmosis.

10. Method according to claim 1, wherein the SO₂ absorbers are operated at pH values in the range 4.5 to 7.5.

11. Method according to claim 1, wherein the ATS reactor is operated at pH values in the range 6.5 to 9.

12. Method according to claim 1, wherein the small amounts of SO₃ formed in step (a) react with water to form sulfuric acid vapor, of which a part condenses as small droplets and wherein an aerosol filter is installed to treat the product gas downstream from step (b) in order to reduce or eliminate emission of sulfuric acid mist in the product gas.

13. Method according to claim 12, wherein the filter is a low velocity candle filter or a wet electrostatic precipitator, and wherein the liquid drain from the filter is optionally returned to the liquid of the second absorber.

14. Method according to claim 1, wherein step (a) also converts sulfur compounds other than H₂S.

15. Method according to claim 1, wherein the oxygen content in the gas leaving the selective catalytic step is below 1%.

16. Method according to claim 1, wherein conventional technology for CO₂ and N₂ removal is installed downstream of the absorption steps, thereby upgrading the gas to natural gas pipeline quality.

17. Method according to claim 1, wherein the inlet temperature to reaction (a) is restricted to levels of less than 350° C., but more than 170° C.
